(19) United States
(12) Patent Application Publication
(10) Pub. No.: US 2026/0152433 A1
(43) Pub. Date: Jun. 4, 2026

(54) HOT END METAL OXIDE COATINGS FOR GLASS SUBSTRATES AND CONTAINERS

(71) Applicant: Arkema Inc., King of Prussia, PA (US)

(72) Inventors: Sandrine Nathalie RIVILLON, King of Prussia, PA (US); Marina DESPOTOPOULOU, King of Prussia, PA (US); Ryan Christopher SMITH, King of Prussia, PA (US); Jean-Pierre DISSON, King of Prussia, PA (US)

(21) Appl. No.: 19/126,298

(22) PCT Filed: Oct. 26, 2023
(86) PCT No.: PCT/US2023/077886

§ 371 Date: May 1, 2025

Related U.S. Application Data
(60) Provisional application No. 63/421,276, filed on Nov. 1, 2022.

(51) Int. Cl. C03C 17/25

(52) U.S. Cl. CPC C03C 17/25; C03C 2217/214; C03C 2218/112

(57) ABSTRACT

A method of coating a glass substrate with a hot end coating is provided. The method includes a step of applying a composition comprising at least one organic salt of a metal onto a surface of the glass substrate to form a hot end coating on the glass substrate. The glass surface has a temperature of from about 450° C. to about 800° C. when the composition comprising at least one organic salt of a metal is applied thereto. After application the hot end coating includes oxide(s) of the metal, or combinations thereof. A coated glass article is also provided. The coating on the glass article is a hot end coating including at least one of Group 3A oxides, Group 4A oxides, or combinations thereof.

### FIELD OF THE INVENTION

The invention relates to hot end metal oxide coatings for glass articles and substrates, such as containers, bottles, and flat glass, methods of applying hot end metal oxide coatings during the manufacture of glass articles and substrates, and to glass articles and substrates coated with such coatings.

### BACKGROUND

Glass articles, especially glass containers and bottles, typically require coatings applied to the surface thereof. The coatings impart desirable properties, such as improved adherence to further coatings which provide additional desirable properties such as scratch protection and durability. Glass containers, especially glass bottles, may be made by a number of methods, but they typically all have in common the following steps:
1. Melting sand with modifiers at temperature above 1200° C. to eventually generate a gob;
2. Forming the hot gob into a container;
3. Optionally, coating the hot container with a coating. This coating, if applied, is referred to as a “hot end” coating. The hot end coatings will protect the glass and may act as a primer to any optional additional coating while at the same time having suitable optical properties so that the resulting container remains clear and lacks iridescence. Hot end coatings also provide a surface that can adhere to any coatings applied later in the process, such as cold end coatings and/or labels or other markings;
4. Cooling the hot container. The cooling is done under controlled conditions because cooling the formed container too fast can cause the container to shatter; and
5. Optionally, applying a coating to the cooled glass container. This coating, if applied, is referred to as a “cold end” coating and typically comprises a wax. These cold end coatings may impart properties such as improved lubricity (e.g. for easier automated handling), scratch resistance, improved durability and strength, and/or improved adherence of labels.

It is desirable to increase the efficiency and safety of the hot end coating process. Currently, some hot end precursors such as monobutyltin trichloride, tin tetrachloride or titanium isopropoxide are applied to the hot glass substrate using a chemical vapor deposition method. In chemical vapor deposition, the material to be used as the coating is vaporized, typically by vaporization of a liquid, usually at an elevated temperature and atmospheric pressure. The vapor deposits on and/or reacts with the hot glass surface. Such a coating (hot end coating) will protect the glass container and is used as a primer for the subsequent deposition of a cold end coating which adheres to the metal oxide surface and protects the glass from scratches and helps to preserve the glass strength. Tin precursors are strongly acidic and the release of HCl from the CVD reaction will corrode the coating equipment used to apply them. An alternative to conventional tin precursors, such as titanium isopropoxide, is flammable and may be hazardous to health. During the CVD process, the build-up on the coating equipment may occur over time leading to stoppage of the process in order to perform regular maintenance of the equipment and cleaning which is inefficient and costly.

Aluminum acetylacetonate, also referred to as Al(acac)₃ may be used in certain processes, especially CVD to produce aluminum oxide as a hot end coating on a glass substrate. However, it is not soluble in water, and has a low vapor pressure. To be useful in CVD it is dissolved in an organic solvent having a low flash point, making it relatively hazardous. Other aluminum oxide precursors also have undesirable environmental and practical limitations for the hot end coating process. Tri-alkyl aluminum compounds are pyrophoric. Aluminum alkoxides tend to polymerize and form gels upon exposure to moisture.

Other coating methods have been described in EP 3 024 792; WO 2012/053919; and in Processing, Properties, and Applications of Glass and Optical Materials: Ceramic Transactions; Edited by Arun K. Varshneya, Helmut A. Schaeffer, Kathleen A. Richardson, Marlene Wightman and L. David Pye; (2012). The aforementioned publications disclose a method of applying powder of Al(OH)₃ onto hot and/or cold glass containers to form a coating. There is described a process where, in order to be able to apply the nanopowder on the glass, the initial material is dry ground by using a mill that could easily contaminate the powder and in turn the resulting coating. Also applying a powered coating onto a hot glass surface, however, may have undesirable environmental and safety limitations, due to the necessity of containing the powder.

WO 2006/060510 describes an alumina dispersion.

U.S. Pat. No. 2,617,741 describes a process of spraying various metal compositions onto a glass substrate to make an intermediate oxide film, which is subsequently coated with oxides of tin, cadmium, or indium, to provide an electroconductive coating layer.

JP H08239240A discloses ultrasonic spraying of aqueous solutions of tin, titanium, or zirconium halogen (e.g. chlorine), acetate, sulfate or nitrate compounds for coating glass at high temperature. The deposition is achieved with a mist (ultrasonic crystal, or blown with a fan/blower) at high temperature to coat the glass with a metal oxide film.

Therefore, a need exists for a method of applying a hot end coating to a glass substrate which is non-corrosive, non-hazardous, provides little to no hazardous emissions, and that avoids build-up on the equipment, while at the same time being efficient, cost effective, safe, environmentally friendly, and which achieves the desirable properties and characteristics of a hot end coating such as being substantially transparent, substantially colorless, and without iridescence.

### SUMMARY

The inventors have surprisingly found that a composition comprising at least one organic salt of a metal may be applied directly onto a hot surface of a glass substrate thereby forming a hot end coating. The surface of the glass substrate may have a temperature of from about 450° C. to about 1000° C. before/during/immediately after applying the composition. The inventors also discovered that spraying, or using chemical vapor deposition (“CVD”), to apply an aqueous composition of the composition comprising at least one organic salt of a metal are suitable methods for applying a hot end coating onto the heated surface of the glass substrate. Upon spraying or CVD the aqueous composition onto the hot glass, a coating comprising oxides of the metal(s) is formed on the glass substrate. The deposited metal oxide coating is substantially transparent or transparent, substantially colorless or colorless, and/or substantially without iridescence or without iridescence to the naked eye. After a hot end coating according to the invention has been applied to a glass surface, optionally an additional cold end coating, preferably in the form of a polymer formulation, can be deposited onto the hot end coating and adhered thereto.

Accordingly, a method of coating a glass substrate with a coating is provided. This coating is a hot end coating. The hot end coating may be inorganic. The method comprises the following steps.
a) Applying a composition comprising at least one organic salt of a metal onto a surface of the glass substrate, the surface having a temperature of from about 450° C. to about 1000° C., thereby forming a hot end coating on the glass substrate. In various embodiments, the surface has a temperature of from 450° C. to 800° C. before, when first applied, during, or after, application of the composition comprising at least one organic salt of a metal. After application of the composition comprising at least one organic salt of a metal, the hot end coating comprises oxide(s) of the metal(s), or combinations thereof.

A coated glass article is also provided. The article comprises a glass substrate and a hot end coating on the glass substrate. The coating comprises at least one of Group 3A oxide(s), Group 4A oxide(s), or combinations thereof, preferably TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, AlₓO_{y} (0<x≤2 and 0<y≤3), or combinations thereof; more preferably Al₂O₃, Al₂O, AlO, AlₓO_{y} (0<x≤2 and 0<y≤3), or combinations thereof.

### DETAILED DESCRIPTION

A method of coating a glass substrate with a coating is provided. The coating is a “hot end” coating to which a “cold end” coating may optionally be applied.

The method comprises the following steps:
a) applying a composition comprising at least one organic salt of a metal onto a surface of the glass substrate, the surface having a temperature of from about 450° C. to about 1000° C., thereby forming a hot end coating on the glass substrate. After application of the composition comprising at least one organic salt of a metal, the hot end coating comprises oxide(s) of the metal, or combinations thereof.

According to an embodiment, the method may further comprise the following steps:
b) optionally cooling the glass substrate and the hot end coating to a temperature of from about 80° C. to about 350° C., preferably from about 100° C. to about 250° C., more preferably between about 100° C. to about 200° C.; and
c) applying a cold end coating composition onto the hot end coating to provide a cold end coating on the hot end coating.

According to another embodiment, the composition comprising the organic salt of a metal is in a form of an aqueous composition which is applied by spraying. The spraying may be done using a sprayer equipped with a nozzle through which the composition or aqueous solution may be atomized at a pressure from about 2 to about 250 psi, or at from about 10 to about 250 psi, or at from about 2 to about 100 psi, or at from about 2 to about 70 psi, or at a pressure between about 10 and about 30 psi. The type of sprayer is not particularly limited, but for example, may use a compressed gas, such as nitrogen, or oxygen, or air as a propellant. The sprayer may be of the airless type, in which case the composition comprising at least one organic salt of a metal is pressurized and no propellant is used. Non-limiting examples of sprayers that may be used are hydraulic, pneumatic, or mechanical atomizers, or combinations thereof. Other non-limiting examples of sprayers that may be used are an ultrasonic atomizer, rotary atomizer, airless atomizer, or electrostatic atomizer, and such sprayers also may be characterized by nozzle and orifice geometry and configuration, spray patterns, droplet size and droplet size distribution which they may produce. Several such technologies are discussed in “Atomization and Sprays,”2nd Edition, by Arthur Lefebvre and Vincent McDonell (CRC Press, 2017) and “Classification of Atomization Devices”, by A. Yu Vasilyev, E. S. Domrina, S. V. Kaufman, and A. I. Maiorova (Journal of Physics: Conference Series 1359 (2019) 012131), the contents of which are incorporated herein.

The composition comprising the organic salt of a metal may have a viscosity from about 1×10⁻⁵ Pa·s to about 100,000 Pa·s, preferably from about 1×10⁻⁴ to about 10,000 Pa·s, and more preferably from about 1×10⁻⁴ to about 1,000 Pa·s, measured at 25° C. at a shear rate of 0.1 s⁻¹. The composition comprising the organic salt of a metals may be a newtonion or non-newtonion fluid.

According to an embodiment, the application of the composition comprising the organic salt of a metal composition onto the surface of the hot glass substrate is performed in air and at atmospheric pressure. This atmospheric pressure refers to the pressure surrounding the hot glass substrate, not the pressure that may be used to spray the composition comprising the organic salt of a metal.

According to another embodiment, the composition comprising an organic salt of a metal may be applied by a process of chemical vapor deposition (CVD) at a pressure of about 1 atm or less. The composition is at ambient temperature and fed into CVD equipment where hot glass travels through. Temperatures typically are between about 125° C. to about 300° C. which causes the solution to evaporate and form a coating on the glass.

According to another embodiment, the composition comprising an organic salt of a metal is in the form of a particulate solid powder and the composition comprising an organic salt of a metal is applied by spraying or blowing the composition, optionally using a gas. The gas may optionally be pressurized.

### Glass Substrate

Non-limiting examples of suitable glass substrates may be silicate glass, quartz glass, borosilicate glass, soda lime glass, crystal glass, aluminosilicate glass, germanium silicate glass, phosphosilicate glass, or crown glass. The glass substrate may comprise from 1 to 100 wt % SiO₂. The glass substrate may comprise other elements such as sodium, calcium, aluminum, iron, magnesium, boron, lead, sulfur, carbon, selenium, chromium, cobalt, nickel, manganese, phosphorus, germanium, and/or potassium. The glass substrate may comprise from 0 to 100 wt % recycled glass.

### Composition Comprising the Organic Salt of a Metal

The composition comprising an organic salt of a metal may be an aqueous composition, i.e., it may further comprise water. This is understood to be water other than water of hydration. The composition comprising an organic salt of a metal may be in the form of a solution, a dispersion, an emulsion, a suspension, a saturated solution, or a colloid. The composition comprising the organic salt of a metal may include a polar solvent or suspending agent, such as water, C1 to C4 alcohols, acetone, acetonitrile, dimethylformamide (DMF), or dimelthylsulfoxide (DMSO), or mixtures thereof, for example. Water or a mixture with water is the preferred solvent.

The composition comprising an organic salt of a metal may be in the form of a solid, a powder, particles, e.g., a particulate solid.

The composition may comprise from about 2wt % to about 100wt % of the organic salt of the metal by weight of the composition. The composition may comprise at least about 5, about 10, about 15, about 20, about 25, about 30, about 35, about 40, about 45, about 50, about 55, about 60, about 65, about 70, about 75, about 80, about 85, about 90, about 95, or at least about 100wt % of the organic salt of the metal by weight of the composition. The composition may comprise at most about 99, about 95, about 90, about 85, about 80, about 75, about 70, about 65, about 60, about 55, about 50, about 45, about 40, about 35, about 30, about 25, about 20, about 15, about 10, or at most about 5 wt % of the organic salt of the metal by weight of the composition. According to an embodiment, the composition may comprise about 1 to about 80 wt %, preferably about 5 to about 60 wt %, more preferably about 10 to about 40 wt %, most preferably about 10 to about 35 wt % of the organic salt of the metal by weight of the composition. According to an embodiment, the composition comprises about 1 to about 80 wt %, preferably about 5 to about 60 wt %, most preferably about 10 to about 60 wt %, of the organic salt of the metal by weight of the composition.

According to an embodiment, the organic salt of the metal comprises at least one of Group 3A C1-C10 organic salts, Group 4 C1-C10 organic salts, or combinations thereof including but not limited to mixtures of said organic salts with other precursors suitable for CVD such as for example MBTC, preferably titanium stearate, titanium lactate, titanium formate, titanium acetate, zirconium stearate, zirconium lactate, zirconium formate, zirconium acetate, aluminum stearate, aluminum lactate, aluminium formate, aluminum acetate, or combinations thereof; more preferably titanium lactate, zirconium lactate, aluminum lactate, or combinations thereof; most preferably aluminum lactate; and/or wherein after application the hot end coating comprises oxides of the metal comprising at least one of Group 3A oxides, Group 4A oxides, or combinations thereof; preferably AlₓO_{y} (0<x≤2 and 0<y≤3), TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, or combinations thereof; more preferably Al₂O₃, Al₂O, AlO, AlₓO_{y} (0<x≤2 and 0<y≤3) or combinations thereof; most preferably γAl₂O₃, and AlₓO_{y} (0<x≤2 and 0<y≤3).

As noted above, when sprayed or otherwise applied onto the surface of the glass substrate, the composition comprising the organic salt of a metal may have a temperature of from about 10° C. to about 70° C., about 15° C. to about 60° C., preferably from about 20° C. to about 50° C. Surprisingly, in view of the large difference between the temperature of the composition comprising the organic salt of a metal and the surface of the glass substrate, the glass substrate does not shatter or weaken. This effect is especially surprising when the composition is in the form of a solution, saturated solution, dispersion, emulsion, or colloid with water or other solvent or carrier, given the added heat capacity of the additional solvent or carrier needed to provide sufficient coverage of the organic salt of a metal to produce an adequate hot end coating layer.

The composition comprising the organic salt of a metal may have a pH less than about 11, or less than about 10, or less than about 9, or less than about 8, preferably from about 1 to about 7, more preferably from about 2 to about 7, even more preferably from about 3 to about 7, most preferably from about 2 to about 5.

According to an embodiment, deionized water may used to form the composition comprising the organic salt of a metal. According to an embodiment, tap water may be used to form the composition comprising the organic salt of a metal.

The composition may further comprise at least one salt, in addition to the organic salt of the metal. This additional salt may comprise at least one of Group 3A or Group 4 elements or combinations thereof, more preferably an aluminum salt, even more preferably at least one salt comprising at least one of aluminum nitrate (Al(NO₃)₃), aluminum sulfate (Al₂(SO₄)₃), or combinations thereof. The composition comprising the organic salt of a metal may comprise from about 1 to about 20 wt % of the salt, from about 1 to about 10 wt % of the salt, preferably from about 3 to about 8 wt % of the salt, more preferably from about 4 to about 8 wt % of the salt, by weight of the composition comprising the organic salt of a metal.

According to an embodiment, the composition comprising the organic salt of a metal may have a viscosity at a shear rate of 0.1 s⁻¹ of about 1,000 Pa·s or less, measured at 25° C. The viscosity of the fluid may be Newtonian or non-Newtonian.

### Other Additives

The composition comprising the organic salt of a metal may further comprise additional additives as are known and used in the art. For example, the composition comprising the organic salt of a metal may comprise one or more of wetting agents, surfactants, emulsifiers, viscosity modifying agents, preservatives, co-solvents, stabilizers, or antimicrobial additives.

### Hot End Coating

After application to the hot surface of the glass substrate, the coating (“hot end” coating) thus formed comprise(s) oxide(s) of the metal. These metal oxide(s) comprise at least one of Group 3A oxides, Group 4A oxides, or combinations thereof; preferably AlₓO_{y} (0<x≤2 and 0<y≤3), TiO₂, TiO, Ti₂O₃, Ti_{z}Oₐ (0<z≤2 and 0<a≤3), ZrO₂, Zr_{b}O_{c} (0<b≤1 and 0<c≤2) Al₂O₃, Al₂O, AlO, AlₓO_{y} (0<x≤2 and 0<y≤3), or combinations thereof; more preferably Al₂O₃, Al₂O, AlO, AlₓO_{y} (0<x≤2 and 0<y≤3), or combination thereof; most preferably γAl₂O₃ or AlₓO_{y} (0<x≤2 and 0<y≤3). The hot end coating may comprise γAl₂O₃ or AlₓO_{y} (0<x≤2 and 0<y≤3).

The hot end coating may be an inorganic coating. According to certain embodiments, the hot end coating formed from the composition comprising the organic salt of a metal is substantially free of halides, preferably substantially free of Cl. Substantially free of halide means less than 10% by weight, or less than 5%, or 1% by weight or less, or 5000 ppm or less, or 1000 ppm or less, or 500 ppm or less, or 100 ppm or less or 50 ppm or less, or 10 ppm or less of halide, based on the weight of the hot end coating.

According to an embodiment, the hot end coating is substantially free of carbon. Substantially free of carbon means less than 10% by weight of carbon, or less than 5% by weight, or 1% by weight or less of carbon, or 5000 ppm or less, or 1000 ppm or less, or 500 ppm or less, or 100 ppm or less or 50 ppm or less, or 10 ppm or less of carbon based on the weight of the hot end coating.

According to certain embodiments, the hot end coating may be substantially free of metals other than aluminum. Substantially free of metals other than aluminum means less than 5% by weight, or less than 3% by weight, or less than 1% by weight, or less than 5000 ppm, or less than 1000 ppm, or less than 500 ppm, or 300 ppm or less of metals other than aluminum, based on the weight of the hot end coating.

According to an embodiment, the coating comprises at least one of AlₓO_{y} (0<x≤2 and 0<y≤3), Al₂O₃, Al₂O, AlO, AlₓO_{y} (0<x≤2 and 0<y≤3) or combinations thereof; more preferably Al₂O₃, Al₂O, AlO, AlₓO_{y} (0<x≤2 and 0<y≤3), or combinations thereof, most preferably AlₓO_{y} (0<x≤2 and 0<y≤3); and the coating is substantially free of metals other than aluminum, halogens, and optionally carbon.

According to an embodiment, the resulting coating comprising the metal oxide(s) is substantially transparent or transparent, substantially colorless or colorless, and/or substantially without or without iridescence to the naked eye. Transparent is defined herein as capable of transmitting light such that the unaided human eye may see through it. Iridescence as defined herein means having a rainbow effect or appearance of the coating as observable by the unaided human eye. Colorless as defined herein means no color is discernable to the unaided human eye. According to an embodiment, the resulting hot end coating comprising the metal oxide(s) is homogeneous. Homogeneous as defined herein means that the hot end coating and/or the metal oxide(s) comprising the hot end coating have a uniform appearance as viewed by the naked eye. According to an embodiment, upon and/or after application of the composition comprising the organic salt of a metal to the hot glass substrate, the hot end coating forms a film which may or may not be continuous.

According to an embodiment, a cold end coating may adhere to the hot end coating comprising the metal oxide(s)

[symbol]

### Coated Glass Article

A coated glass substrate produced by the method disclosed herein is provided. The coated glass article comprises:
a glass substrate and
a hot end coating on the glass substrate,
the hot end coating comprises at least one of Group 3A oxides, Group 4A oxides, or combinations thereof, preferably TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, AlₓO_{y} (0<x≤2 and 0<y≤3) or combinations thereof; more preferably Al₂O₃, Al₂O, AlO, AlₓO_{y} (0<x≤2 and 0<y≤3); or combinations thereof; most preferably AlₓO_{y} (0<x≤2 and 0<y≤3).

According to an embodiment, the hot end coating is substantially free of halides, preferably substantially free of Cl. As used herein, substantially free of means less than 1% by weight of halide, or less than 5000 ppm, or less than 1000 ppm, or less than 500 ppm, or less than 100 ppm, or less than 50 ppm, or less than 10 ppm, of halide, based on the weight of the hot end coating. According to an embodiment, deionized water may be used to form the composition comprising the organic salt of a metal. According to an embodiment, tap water may used to form the composition comprising the organic salt of a metal. According to an embodiment, the hot end coating is substantially free of carbon. According to certain embodiments, the hot end coating may be substantially free of metals other than aluminum. Substantially free of means less than 1% by weight of metal other than aluminum, or less than 5000 ppm, or less than 1000 ppm, or less than 500 ppm, or less than 100 ppm, or less than 50 ppm, or less than 10 ppm of metal other than aluminum, by weight of the hot end coating.

According to an embodiment, the hot end coating comprises at least one of AlₓO_{y} (0<x≤2 and 0<y≤3), Al₂O₃, Al₂O, AlO, AlₓO_{y} (0<x≤2 and 0<y≤3), γAl₂O₃, or combinations thereof; more preferably Al₂O₃, Al₂O, AlO, AlₓO_{y} (0<x≤2 and 0<y≤3), or combinations thereof, most preferably AlₓO_{y} (0<x≤2 and 0<y≤3); and the coating is substantially free of metals other than aluminum. Substantially free of means less than 1% by weight, or less than 5000 ppm, or less than 1000 ppm, or less than 500 ppm of metal other than aluminum by weight of the hot end coating.

According to an embodiment, the coated glass article further comprises a cold end coating on the hot end coating.

According to an embodiment, the coated glass article comprises at least one of a hollow glass container, bottle, or flat glass.

### Emissions During the Coating Process

According to an embodiment, the coating process results in the release of (emissions of) essentially only water. “Essentially only water” as used herein means that the coating process results in emissions of halogens and/or carbons that are <10%, or <5%, <3%, <2%, <1%, <0.5% by weight of the aqueous dispersion composition that is applied to the hot surface of the glass substrate to produce the metal(s) oxide hot end coating on the surface of the glass substrate.

Exemplary aspects of the invention may be summarized as follows.

Aspect 1: A method of coating a glass substrate with a hot end coating, comprising:
a) applying a composition comprising at least one organic salt of a metal onto a surface of the glass substrate, the surface having a temperature of from about 450° C. to about 800° C., thereby forming the hot end coating on the glass substrate, said hot end coating preferably being an inorganic coating;
wherein after application the hot end coating comprises oxide(s) of the metal(s), or combinations thereof.

Aspect 2: The method of Aspect 1, wherein the composition comprising the organic salt of a metal is in a form of an aqueous composition.

Aspect 3: The method of Aspect 1 or Aspect 2, wherein the organic salt of the metal comprises at least one of Group 3A C1-C10 organic salts, Group 4 C1-C10 organic salts, or combinations thereof; preferably titanium stearate, titanium lactate, titanium formate, titanium acetate, zirconium stearate, zirconium lactate, zirconium formate, zirconium acetate, aluminum stearate, aluminum lactate, aluminium formate, aluminum acetate, or combinations thereof; more preferably titanium lactate, zirconium lactate, aluminum lactate, or combinations thereof; most preferably aluminum lactate; and/or
wherein after application the hot end coating comprises oxides of the metal comprising at least one of Group 3A oxides, Group 4A oxides, or combinations thereof; preferably AlₓO_{y} (0<x≤2 and 0<y≤3), TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, AlₓO_{y} (0<x≤2 and 0<y≤3) or combinations thereof, more preferably Al₂O₃, Al₂O, AlO, AlₓO_{y} (0<x≤2 and 0<y≤3) or combinations thereof; most preferably AlₓO_{y} (0<x≤2 and 0<y≤3).

Aspect 4: The method of any of Aspects 1-3, wherein the composition has a pH less than about 8, preferably from about 1 to about 7, more preferably from about 2 to about 7, even more preferably from about 3 to about 7, most preferably from about 3-5.

Aspect 5: The method of any of Aspects 1-4, wherein the composition comprises about 1 to about 80 wt %, preferably about 5 to about 70 wt %, most preferably about 10 to about 60 wt %, of the organic salt of the metal by weight of the composition.

Aspect 6: The method of any of Aspects 1-5, wherein the composition further comprises at least one salt, preferably aluminum nitrate (Al(NO₃)₃), or aluminum sulfate (Al₂(SO₄)₃), or combinations thereof.

Aspect 7: the method of any of aspects 1-6, further comprising
b) optionally cooling the glass substrate and the hot end coating to a temperature of from about 80° C. to about 350° C., preferably from about 100° C. to about 250° C., more preferably between about 100° C. to about 200° C.; and
c) applying a cold end coating composition onto the hot end coating to provide a cold end coating on the hot end coating.

Aspect 8: The method of any of Aspects 1-7, wherein the composition is in a form of an aqueous solution and the aqueous solution is applied by spraying, optionally using a sprayer optionally at a pressure of the solution between about 1 and about 250 psi, or at about 2 to about 100 psi, or at about 2 to about 70 psi, or between about 10 and about 30 psi.

Aspect 9: The method of any of Aspects 1-8, wherein the composition is applied by a process of chemical vapor deposition (CVD) at about atmospheric pressure.

Aspect 10: The method of any of Aspects 1, 3-7, and 9, wherein the composition is in a form of a particulate solid powder and the composition is applied by spraying or blowing the composition using a gas.

Aspect 11: The method of any of Aspects 1-10, wherein the hot end coating is substantially free of halides, preferably substantially free of Cl.

Aspect 12: The method of any of Aspects 1-11, wherein the hot end coating comprises at least one of Group 3A oxides, Group 4A oxides, or combinations thereof; preferably TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, AlₓO_{y} (0<x≤2 and 0<y≤3), or combinations thereof; more preferably Al₂O₃, Al₂O, AlO, AlₓO_{y} (0<x≤2 and 0<y≤3); or combinations thereof, most preferably AlₓO_{y} (0<x≤2 and 0<y≤3).

Aspect 13: The method of any of Aspects 8-14, wherein a cold end coating is applied over the hot end coating.

Aspect 14: The method of any of Aspects 1-13, wherein the hot end coating is substantially transparent, colorless, and/or without iridescence to the naked eye.

Aspect 15: The method of any of Aspects 1-14 wherein the hot end coating is homogeneous.

Aspect 16: The method of any of Aspects 1-15 wherein the composition further comprises one or more of wetting agents, surfactants, viscosity modifying agents, preservatives, stabilizers, co-solvents, and/or antimicrobial additives.

Aspect 17: A coated glass substrate prepared by the method of any of Aspects 1-16.

Aspect 18: A coated glass article comprising:
a glass substrate and
a hot end coating on the glass substrate,
wherein the glass substrate comprises SiO₂ (silica) and the hot end coating comprises at least one of Group 3A oxides, Group 4A oxides, or combinations thereof; preferably TiO₂, TiO, Ti₂O₃, Ti_{z}Oₐ (0<z≤2 and 0<a≤3), ZrO₂, Zr_{b}O_{c} (0<b≤1 and 0c≤2), Al₂O₃, Al₂O, AlO, AlₓO_{y} (0<x≤2 and 0<y≤3), or combinations thereof; more preferably Al₂O₃, Al₂O, AlO, AlₓO_{y} (0<x≤2 and 0<y≤3), or combinations thereof; most preferably AlxOy (0<x≤2 and 0<y≤3).

Aspect 19: The coated glass article of Aspect 18, wherein the hot end coating is substantially free of halides, preferably substantially free of Cl.

Aspect 20: The coated glass article of Aspect 18 or Aspect 19, further comprising a cold end coating on the hot end coating.

Aspect 21: The coated glass article of any of Aspects 18-20, wherein the coated glass article comprises at least one of a hollow glass container, or flat glass.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the compositions, methods for making the compositions, methods for using the compositions, and articles prepared from the compositions. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Methods

Temperatures of the glass substrate were measured by a pyrometer (emissivity of the coated soda lime glass surfaces was 0.95).

The Scanning Electron Microscopy was performed using a Hitachi Su 8010 instrument.

First, a solution of 20 wt % aluminum lactate in water was prepared. The solution of aluminum lactate was prepared by slowly adding aluminum to deionized water to prepare an aqueous solution including 20 wt % of aluminum lactate by weight of the aqueous solution. During preparation, the solution was continuously mixed even after the aluminum lactate had been completely dissolved in the water. A clean piece of soda lime glass was annealed on a hot plate to a temperature higher than 400° C. (530° C. to 540° C.), as measured using a pyrometer. When the glass temperature had reached 400° C. or higher, i.e., from 530° C. to 540° C., the hot glass surface was sprayed from 1 to 3 times with the prepared aqueous solution using an air brush (Grex, model Tritium), equipped with a crown nozzle. The air pressure in the air brush was varied between 10 and 40 psi. After the aqueous solution was applied, the glass substrate and its hot end coating were allowed to cool down until it reached 125° C. The coatings were transparent and colorless and lacked iridescence. When the glass substrate and its hot end coating reached 125° C., a wax emulsion cold end coating (Tegoglas® RP-40, Arkema) was sprayed onto the hot end coating using the same airbrush at an air pressure of 15 psi with the nozzle fully opened.

The metal oxide coating may be in the form of “islands” substantially uniformly distributed on the surface of the soda lime glass substrate. The composition of each of these islands may be substantially homogeneous or not. The volume average particle size of these islands may be the volume average particle size of the metal oxide layer. The metal oxide coating may form a film which may be continuous.

1. A method of coating a glass substrate with a hot end coating, comprising:
a) applying a composition comprising at least one organic salt of a metal onto a surface of the glass substrate, the surface having a temperature of from about 450° C. to about 800° C., thereby forming the hot end coating on the glass substrate, said hot end coating preferably being an inorganic coating;
wherein after application, the hot end coating comprises oxide(s) of the metal(s), or combinations thereof.

2. The method of claim 1, wherein the composition comprising the at least one organic salt of the metal is an aqueous composition.

3. The method of claim 1, wherein the organic salt of the metal comprises at least one of Group 3A C1-C10 organic salts, Group 4 C1-C10 organic salts, or combinations thereof; and/or
wherein after application, the hot end coating comprises oxides of the metal comprising at least one of Group 3A oxides, Group 4A oxides, or combinations thereof.

4. The method of claim 1, wherein the composition has a pH less than about 8.

5. The method of claim 1, wherein the composition comprises about 1 wt % to about 80 wt % of the organic salt of the metal by weight of the composition.

6. The method of claim 1, wherein the composition further comprises at least one salt selected from aluminum nitrate (Al(NO₃)₃), aluminum sulfate (Al₂(SO₄)₃), or combinations thereof.

7. The method of claim 1, further comprising:
b) optionally cooling the glass substrate and the hot end coating to a temperature of from about 80° C. to about 350° C.; and
c) applying a cold end coating composition onto the hot end coating.

8. The method of claim 1, wherein the composition is an aqueous solution applied by spraying, optionally at a pressure of the solution between about 10 to about 250 psi.

9. The method of claim 1, wherein the composition is applied by chemical vapor deposition (CVD) at about atmospheric pressure.

10. The method of claim 1, wherein the composition is in a form of a solid, and the composition is applied by spraying or blowing the composition using a gas.

11. The method of claim 1, wherein the hot end coating is substantially free of halides.

12. The method of claim 1, wherein the hot end coating comprises at least one of TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, AlₓO_{y} (0<x≤2 and 0<y≤3), or combinations thereof.

13. The method of claim 1, wherein a cold end coating is applied over the hot end coating that adheres to the coated glass surface.

14. The method of claim 1, wherein the hot end coating is transparent, colorless, and/or without iridescence to the naked eye.

15. The method of claim 1, wherein the hot end coating is homogeneous.

16. The method of claim 1, wherein the composition further comprises one or more of wetting agents, surfactants, viscosity modifying agents, preservatives, stabilizers, co-solvents, and antimicrobial additives.

17. A coated glass substrate prepared by the method of claim 1.

18. A coated glass article comprising:
a glass substrate; and
a hot end coating on the glass substrate,
wherein the glass substrate comprises SiO₂ (silica) and the hot end coating comprises at least one of Group 3A oxides, Group 4A oxides, or combinations thereof.

19. The coated glass article of claim 18, wherein the hot end coating is substantially free of halides.

20. The coated glass article of claim 18, further comprising a cold end coating on the hot end coating.

21. The coated glass article of claim 18, wherein the coated glass article comprises at least one of a hollow glass container or flat glass.

22. The method of claim 3, wherein the organic salt of the metal comprises at least one of titanium stearate, titanium lactate, titanium formate, titanium acetate, zirconium stearate, zirconium lactate, zirconium formate, zirconium acetate, aluminum stearate, aluminum lactate, aluminium formate, aluminum acetate, or combinations thereof; and/or
wherein after application, the hot end coating comprises at least one of AlₓO_{y} (0<x≤2 and 0<y≤3), TiO₂, TiO, Ti₂O₃, Ti_{z}Oₐ (0<z≤2 and 0<a≤3), ZrO₂, Zr_{b}O_{c} (0<b≤1 and 0<c≤2), Al₂O₃, Al₂O, AlO, or combinations thereof.

23. The coated glass article of claim 18, wherein the hot end coating comprises at least one of TiO₂, TiO, Ti₂O₃, Ti_{z}Oₐ (0<z≤2 and 0<a≤3), ZrO₂, Zr_{b}O_{c} (0<b≤1 and 0c≤2), Al₂O₃, Al₂O, AlO, AlₓO_{y} (0<x≤2 and 0<y≤3), or combinations thereof.
